(19) United States
(12) Patent Application Publication
(10) Pub. No.: US 2018/0279370 A1
(43) Pub. Date: Sep. 27, 2018

(54) METHOD OF SUPPORTING MULTIPLE QOS IN A LISTEN-BEFORE-TALK OPERATION

(71) Applicant: Alcatel Lucent, Nozay (FR)

(72) Inventors: Tao Tao, Shanghai (CN); Jianguo Liu, Shanghai (CN); Feng Han, Shanghai (CN); Yan Meng, Shanghai (CN); Junrong Gu, Shanghai (CN); Gang Shen, Shanghai (CN)

(73) Assignee: Alcatel Lucent, Nozay (FR)

(21) Appl. No.: 15/762,389

(22) PCT Filed: Sep. 5, 2016
(86) PCT No.: PCT/IB2016/001390

§ 371 Date: Mar. 22, 2018

(30) Foreign Application Priority Data
Sep. 25, 2015 (CN) 201510623089.1

(51) Int. Cl. H04W 74/08; H04W 16/14; H04W 28/02

(52) U.S. Cl. CPC H04W 74/0816; H04W 28/0268; H04W 16/14

(57) ABSTRACT

The present disclosure provides a method of supporting multiple Qo S in a Listen-Before-Talk operation. According to an embodiment of the present disclosure, the method comprises: configuring m Listen-Before-Talk priority classes, which are defined by m different parameter sets respectively; determining Listen-Before-Talk priority classes for respective traffic in a transmission burst; and selecting one of the determined Listen-Before-Talk priority classes as a Listen-Before-Talk priority class for access. Through the present disclosure, the coexistence between LTE LAA and WiFi can be realized in respect of the Qo S priority, and the scheduling flexibility of LAA is still retained.

### TECHNOLOGY

The present disclosure relate to mobile communication technology, and particularly to a method of supporting multiple QoS in a Listen-Before-Talk (LBT) operation.

### BACKGROUND

In a WiFi system, enhanced distributed channel access (EDCA) is an extension of the basic Distributed Coordination Function (DCF) to support prioritized multiple quality of service (QoS). The EDCA mechanism defines four access categories (AC). Each AC is characterized by a set of specific access parameters (e.g., a defer period, a contention window size, a transmission opportunity and etc.). By using those parameters, each AC can be prioritized. Under the EDCA mechanism, the egress traffic (i.e. traffic leaving the system) is sorted logically into four queues and one queue for one AC.

Considering the coexistence fairness with other technologies (e.g. WiFi), it is beneficial to provision different prioritized QoS when designing the access stage of Licensed-Assisted Access (LAA).

The downlink Listen-Before-Talk (DL LBT) procedure for LTE LAA has been discussed in the study item, and it is recommended that a Category 4 LBT mechanism is the baseline for LAA DL transmission bursts containing PDSCH. Since current Category 4 LBT scheme requires setting a set of parameters, it may require different sets of LBT parameters for the DL transmission of the data traffic with different QoS requirements.

Further, different from WiFi, a legacy LTE scheduler is able to schedule different QoS traffic in one subframe for different user equipments (UE) or the same UE. In WiFi, only one user will use the channel at the same time, and only one kind of traffic is transmitted. Thus, a plurality of “access engines” can be set in WiFi. If one AC wins the contention, only the traffic of the QoS type of this AC in the buffer can be generated as a packet and then be transmitted. Therefore, if a plurality of access engines are copied from WiFi into LAA, the LTE system will lose the original scheduling flexibility.

### SUMMARY

Thus, it is required to design a LBT operation scheme to support different QoS requirements in LTE LAA.

According to the present disclosure, it is proposed a method of supporting multiple QoS in a Listen-Before-Talk operation comprising: configuring m Listen-Before-Talk priority classes defined respectively by m different parameter sets; determining Listen-Before-Talk priority classes for respective traffic in a transmission burst; and selecting one of the determined Listen-Before-Talk priority classes as a Listen-Before-Talk priority class for access.

Advantageously, the parameter set includes: a defer period and a contention window size.

Advantageously, the defer period is determined with the following equation:

16 us+n×eCCASlotTime

wherein eCCSlotTime is at least 9 us, and n is selected according to different Listen-Before-Talk priority classes.

Advantageously, m equals to 4, and n is 2, 2, 3 and 7, respectively, according to a descending order of the Listen-Before-Talk priority classes.

Advantageously, for respective Listen-Before-Talk priority classes, a size is selected randomly from an interval of [0, CW] as a random backoff counter window size, wherein CW is the contention window size and is in a range of [CWₘᵢₙ, CWₘₐₓ] and different ranges of [CWₘᵢₙ, CWₘₐₓ] are defined for the respective Listen-Before-Talk priority classes.

Advantageously, the parameter set further includes a transmission opportunity. Herein, the transmission opportunity of a Listen-Before-Talk priority class with a high priority is less than the transmission opportunity of a Listen-Before-Talk priority class with a low priority. Alternatively, the transmission opportunity is configured according to enhanced distributed channel access parameters in a WiFi system.

Advantageously, the step of determining Listen-Before-Talk priority classes for respective traffic in a transmission burst further comprises: determining the Listen-Before-Talk priority classes for the respective traffic according to traffic in a buffer; or determining the Listen-Before-Talk priority classes for the respective traffic according to traffic in a first frame of the transmission burst.

Advantageously, the Listen-Before-Talk priority class for access is a Listen-Before-Talk priority class with a highest priority or a Listen-Before-Talk priority class with a lowest priority

Advantageously, the parameter set includes a transmission opportunity if the Listen-Before-Talk priority class for access is the Listen-Before-Talk priority class with the highest priority.

Through the present disclosure, the coexistence between LTE LAA and WiFi can be realized in respect of the QoS priority, and the scheduling flexibility of the LAA is retained. Additionally, in the case of the maximum alignment with the existing EDCA in WiFi, only one common access engine is used for the LAA, and a plurality of Listen-Before-Talk priority classes are given by different LBT parameters.

### BRIEF DESCRIPTION OF THE DRAWINGS

Other features, objects and advantages of the invention will become more apparent upon review of the following detailed description of non-limiting embodiments taken with reference to the drawings in which:

FIG. 1 illustrates performing a LBT operation by using one common access engine according to one embodiment of the present disclosure;

FIG. 2 illustrates performing a LBT operation by using one common access engine according to another embodiment of the present disclosure;

FIG. 3 illustrates performing a LBT operation by using one common access engine according to a further embodiment of the present disclosure; and

FIG. 4 illustrates performing a LBT operation by using one common access engine according to one embodiment of the present disclosure.

In the drawings, identical or like reference numerals denote identical or corresponding components or features throughout the different figures.

### DETAILED DESCRIPTION

In order to support multiple QoS in the LAA, LBT priority class (LPC) with different LBT parameters should be firstly specified. In one embodiment of the present disclosure, the following parameters and the corresponding conditions would be considered for the LAA LBT parameters to align with the configuration in WiFi.

1. Configuring a defer period (e.g. the defer period of Extended Clear Channel Assessment (eCCA)) to align with the corresponding configuration in WiFi.

In one embodiment of the present disclosure, the defer period is determined with the following equation:

16 us+n×eCCASlotTime

wherein eCCSlotTime is at least 9 us, and n is different according to the different LPCs. Herein, eCCSlotTime is the time used for a clear channel assessment.

Herein, n is selected, such that the coexistence fairness between LAA and WiFi is ensured.

Advantageously, in one embodiment of the present disclosure, there are four LPCs. According to the descending order of the priority, they are LPC 1, LPC 2, LPC 3 and LPC 4. According to one embodiment of the present disclosure, for the above four LPCs, n is selected as 2, 2, 3 and 7, respectively.

2. Configuring a contention window size (CWS). For different LPCs, a size is selected randomly from the interval of [0, CW] as the random backoff counter contention size (in units of eCCA slots). Herein, CW is the contention window size and is in a range of [CWₘᵢₙ, CWₘₐₓ]. For each LPC, a set of [CWₘᵢₙ, CWₘₐₓ] is defined to distinguish the priority for the channel access of LBT.

In addition to the above two kinds of parameters, the following parameter could be also considered: a transmission opportunity (TXOP). TXOP refers to the maximum period in which one node transmits one kind of prioritized traffic. The configuration of TXOP can promotes the resource fairness, since all nodes with different classes of traffic, which require to access the network, will receive the same amount of air time on average.

According to one embodiment of the present disclosure, the TXOP of a LPC with a high priority is less than the TXOP of a LPC with a low priority.

According to another embodiment of the present disclosure, the TXOP of the different LPCs can be configured according to enhanced distributed channel access (EDCA) parameters in WiFi to ensure the coexistence fairness.

Table 1 illustrates an example of the LPC configuration

TABLE 1
LAA LBT parameters with prioritized QoS

| LBT | | | | | | |
|---|---|---|---|---|---|---|
| priority | | | | | | |
| class | Priority | n | CWₘᵢₙ | CWₘₐₓ | TXOP | Service Type |
| 1 | Highest | 2 | 3 | 7 | 2 ms | Voice |
| 2 | Next highest | 2 | 7 | 15 | 3 ms | Video |
| 3 | Typical | 3 | 15 | 1023 | 4 ms | Best effort |
| 4 | Lowest | 7 | 15 | 1023 | 10 ms | Background |

In the following embodiments, the values of the respective parameters in Table 1 would be used accordingly. However, it is appreciated for those skilled in the art that the above values are only exemplary, but not limited.

In another aspect, as described above, in order to support multiple QoS, for each AC, WiFi uses a plurality of access engines. Also, the backoff mechanism in each access engine operates relative independently. In the LAA, the scheduling is more flexible than WiFi and the data is prepared before channel contention, since a FDM system is used. Thus, the individual operation of a plurality of access engines in WiFi is not suitable for the LAA LBT.

Therefore, according to the present disclosure, only one common access engine is used for the channel access opportunity, although different LPCs have different LBT parameters.

1. LPC for Access and LBT Parameter

If a transmission burst in the downlink transmission includes a plurality of traffic corresponding to different LPCs, only one kind of LPC will be selected as the LPC for access. The LBT parameters in the selected LPC are used as the LBT parameters for access.

Specifically, firstly, according to one embodiment of the present disclosure, the LPCs for the respective traffic can be determined according to the respective traffic in a first frame of the transmission burst.

Alternatively, according to another embodiment of the present disclosure, the LPCs for the respective traffic can be determined according to the respective traffic in a buffer.

After determining the LPCs for the respective traffic, one LPC is selected from the determined LPCs.

Advantageously, the selected LPC is the LPC with the lowest priority to ensure the QoS of the traffic with the highest priority.

Alternatively, the selected LPC is the LPC with the highest priority. In this case, the parameters of the LAA LBT can include TXOP advantageously. Thus, compared with WiFi, the LAA would not be too aggressive, which means only one access engine is used.

The LBT operation procedure when using one access engine would be described in detail in the following.

2. Adaptation Rule for the Contention Window

Scheme 1:

The CWS in the LPC will be updated based on the result of the CWS trigger condition. Herein, this kind of update is conditional, which means the update is not performed for the CWS of all LPCs.

Specifically, if a CWS trigger condition triggers a binary exponential backoff, the binary exponential backoff is performed for the CWS of the LPC, the CWS of which is not greater than the used CWS. If a CWS trigger condition triggers a reset, the CWS of the LPC, the CWS of which is not less than the used CWS, is reset to the respective CWₘᵢₙ. In the above procedure, other LPCs maintain their CWS value unchanged.

The CWS trigger mechanism and conditions are appreciated for those skilled in the art. For example, the trigger can be based on the amount of ACK/NACK messages. For example, if the transmission is successful, the trigger condition triggers a reset. By contrast, if the transmission fails or is not good, the trigger condition triggers a binary exponential backoff. The details would be omitted here.

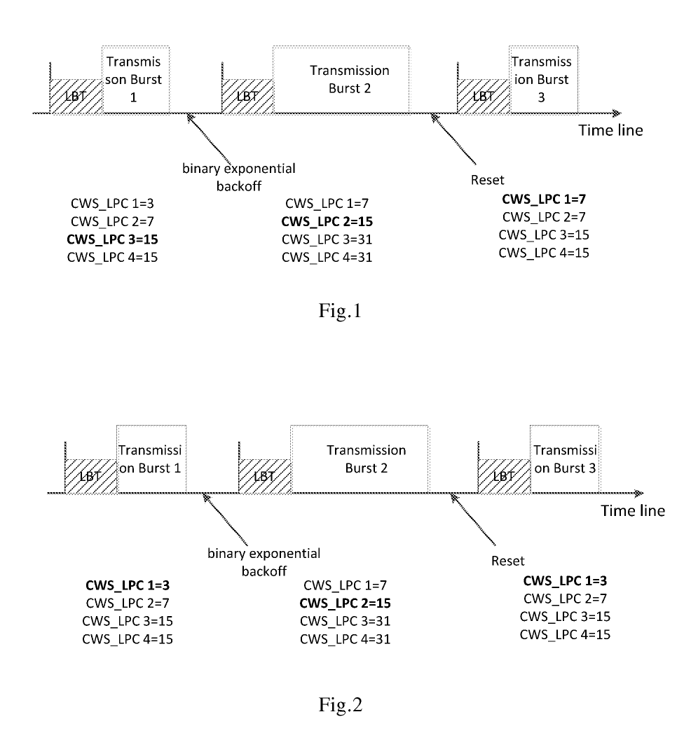

FIG. 1 illustrates performing a LBT operation by using one common access engine according to one embodiment of the present disclosure.

In order to align with WiFi, in this embodiment, four kinds of LPCs are adopted in the LAA. Herein, it is assumed that the LPC for access selected by the transmission burst 1, the transmission burst 2 and the transmission burst 3 is LPC 3, LPC 2 and LPC 1, respectively.

Specifically, the LPC for access and the related parameters in the respective transmission bursts can be determined according the method described above. Herein, it is assumed that the highest priority in the transmission burst 1 is LPC 3, the highest priority in the transmission burst 2 is LPC 2, and the highest priority in the transmission burst 3 is LPC 1. In this embodiment, the selected LPC for access is the LPC with the highest priority.

In another aspect, the CWSs used for different LPCs are always stored in a base station. In this embodiment, for the transmission burst 1, the CWS of LPC 1, LPC 2, LPC 3 and LPC 4 is 3, 7, 15 and 15, for example.

As shown in FIG. 1, before the LBT operation for the transmission burst 2, since the CWS trigger condition triggers a binary exponential backoff, the binary exponential backoff is performed for the CWS in the LPC in the transmission burst 1, the CWS of which is not greater than the CWS used in the transmission burst 1. Herein, since the CWS used in the transmission burst 1 CWS_LPC 3=15, the binary exponential backoff is performed for the CWS of LPC 1, LPC 2, LPC 3 and LPC 4. Thus, the CWS of LPC 1, LPC 2, LPC 3 and LPC 4 in the transmission burst 2 is updated as 7, 15, 31 and 31, respectively.

Herein, the equation of the binary exponential backoff is 2ⁿ−1, for example. For example, for LPC 1 in the transmission burst 1, n is 2. Since the binary exponential backoff (i.e. double) is performed for the CWS of the LPC 1 in the transmission burst 1, n is 3. Thus, the CWS of the LPC 1 in the transmission burst 2 is changed to 7. The similar computation manner would be adopted for other situations, and the details would be omitted here.

Then, the CWS of LPC 2 is used in the transmission burst 2. Before the LBT operation for the transmission burst 3, since the CWS trigger condition triggers a reset, the CWS in the LPCs (i.e., LPC 2, LPC 3 and LPC 4 in the transmission burst 2), the CWS of which is not less than the CWS used in the transmission burst 2, is reset to the respective CWₘᵢₙ. Thus, the CWS of LPC 2, LPC 3 and LPC 4 is reset to 7, 15 and 15, and the CWS of LPC 1 maintains the previous value. Thereby, the CWS of LPC 1, LPC 2, LPC 3 and LPC 4 in the final transmission burst 3 will be 7, 7, 15 and 15. In the transmission burst 3, the CWS of LPC 1 will be used.

Scheme 2:

The CWS in all LPCs will be updated based on the result of the CWS trigger condition. Specifically, when the CWS trigger condition triggers doubling, a binary exponential backoff should be performed for the CWS of all LPCs. When the CWS trigger condition trigger a reset, the CWS of all LPCs will be reset to the corresponding CWₘᵢₙ.

FIG. 2 illustrates performing a LBT operation by using one common access engine according to another embodiment of the present disclosure.

Similar with the previous embodiment, in order to align with WiFi, four kinds of LPCs are still adopted advantageously in the LAA. Herein, it is assumed that the LPC for access selected by the transmission burst 1, the transmission burst 2 and the transmission burst 3 is LPC 1, LPC 2 and LPC 1, respectively.

Similarly, the LPC for access and the related parameters in the respective transmission bursts can be determined according the method described above. Herein, it is assumed that the highest priority in the transmission burst 1 is LPC 1, the highest priority in the transmission burst 2 is LPC 2, and the highest priority in the transmission burst 3 is LPC 1. In this embodiment, the selected LPC for access is the LPC with the highest priority.

For the transmission burst 1, the CWS of LPC 1, LPC 2, LPC 3 and LPC 4 is 3, 7, 15 and 15, respectively.

As shown in FIG. 2, before the LBT operation for the transmission burst 2, since the CWS trigger condition triggers a binary exponential backoff, the binary exponential backoff is performed for the CWS of all LPCs (i.e., LPC 1, LPC 2, LPC 3 and LPC 4) in the transmission burst 1. Thus, the CWS of the LPC 1, LPC 2, LPC 3 and LPC 4 in the transmission burst 2 will be changed to 7, 15, 31 and 31. In the transmission burst 2, the CWS of LPC 2 is used. Before the LBT operation for the transmission burst 3, since the CWS trigger condition triggers a reset, the CWS of all LPCs (i.e., LPC 1, LPC 2, LPC 3 and LPC 4) in the transmission burst 2 is reset to the corresponding CWₘᵢₙ. Thus, the CWS of LPC 1, LPC 2, LPC 3 and LPC 4 will be changed to 3, 7, 15 and 15. In the transmission burst 3, the CWS of LPC 1 will be used.

Scheme 3:

Only the LPC for access in the previous transmission burst will update its CWS, and other LPCs maintain their CWS value unchanged.

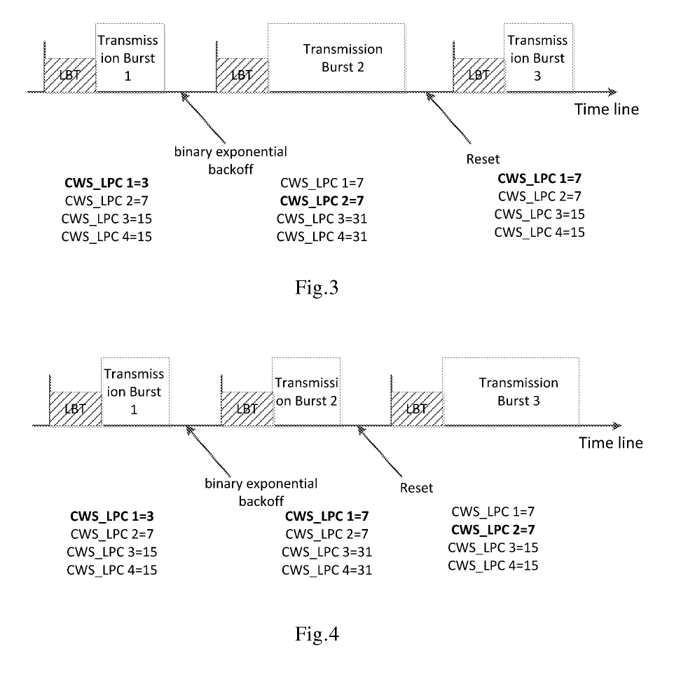

FIG. 3 illustrates performing a LBT operation by using one common access engine according to a further embodiment of the present disclosure. The scenario in FIG. 3 is similar with that in FIG. 2. Herein, it is assumed that the LPC for access selected by the transmission burst 1, the transmission burst 2 and the transmission burst 3 is LPC 1, LPC 2 and LPC 1, respectively.

For the transmission burst 1, the CWS of LPC 1, LPC 2, LPC 3 and LPC 4 is 3, 7, 15 and 15, respectively.

As shown in FIG. 3, before the LBT operation for the transmission burst 2, since the CWS trigger condition triggers a binary exponential backoff, the binary exponential backoff is then only performed for the CWS of LPC 1 in the transmission burst 1, the CWS of LPC 1 is backoff to 7 and is applied to LPC 1 in the transmission burst 1, while the CWS of LPC 2, LPC 3 and LPC 4 is still 7, 15 and 15. The CWS of LPC2 will be used in the transmission burst 2 to generate the backoff counter. Before the LBT operation for the transmission burst 3, since the CWS trigger condition triggers a reset, only the CWS of LPC 2 in the transmission burst 2 is reset to CWₘᵢₙ and CWₘᵢₙ is applied to LPC 2 in the transmission burst 3. As the CWS of LPC 2 is already 7, the above reset does not generate any change. In the transmission burst 3, the CWS of LPC 1 will be used.

Scheme 4:

If the selected LPC in the current transmission burst is different from the selected LPC in the previous transmission burst (i.e., the traffic transmitted by the two continuous transmission bursts is discontinuous), the CWS of the selected LPC in the current transmission burst will be started with CWₘᵢₙ, without considering the result of the CWS triggering condition.

By contrast, if they are same, the result of the CWS triggering condition will be still considered, and the CWS of the LPC for access in the previous transmission burst will be updated correspondingly, and will be used for the CWS of the LPC, which is same as the LPC for access in the previous transmission burst, in the current transmission burst.

FIG. 4 illustrates performing a LBT operation by using one common access engine according to one embodiment of the present disclosure.

Herein, it is assumed that the LPC for access selected by the transmission burst 1, the transmission burst 2 and the transmission burst 3 is LPC 1, LPC 1 and LPC 2, respectively.

For the transmission burst 1, the CWS of LPC 1, LPC 2, LPC 3 and LPC 4 is 3, 7, 15 and 15, for example.

In this embodiment, the selected LPC for access is the LPC with the highest priority.

Since the highest priority (i.e. the current selected priority) of the transmission burst 1 and the transmission burst 2 is identical (i.e. the traffic of the two transmission bursts is continuous), a binary exponential backoff is triggered to be performed for the CWS of LPC 1 and the CWS after the binary exponential backoff will be used in the transmission burst 2. Thus, the CWS of LPC 1 in the transmission burst 2 is changed to 7, and the CWS of other LPCs maintains unchanged.

During the procedure from the transmission burst 2 to the transmission burst 3, since the highest priority is changed from LPC 1 to LPC 2, the traffic of the two transmission bursts is discontinuous. Thus, the CWS of LPC 2 in the transmission burst 3 is 7. Herein, the CWS of LPC 2 is already 7, thus the above reset does not generate any change.

For the case in which the result of the CWS triggering condition will still be considered when the two selected priority is identical, the implementation procedure is same as scheme 3, and would be omitted here.

Additionally, advantageously, if the CW is adjusted based on HARQ-ACK feedback, the CWS trigger condition may take all or partial ACK/NACK feedback into consideration. Herein, the ACK/NACK feedback from one LPC could only affect the CWS adaptation of that LPC.

Advantageously, a reset condition can be introduced, when a LPC is not used for long period.

One common access engine for LBT as proposed herein also supports MU-MIMO. For example, a multi-user transmission may be scheduled to transmit voice traffic to a user equipment and then that transmission time is used to also send lower-priority data to other UEs at the same time. Through the present disclosure, only one LBT priority class (e.g., the highest priority) drives the transmitter to gain the control of the channel. In this case, the low priority traffic may access to the medium more quickly than they would in the single-user transmission. Also, the channel occupancy time will not be increased due to TXOP constraint.

It shall be appreciated that the foregoing embodiments are merely illustrative but will not limit the invention. Any technical solutions without departing from the spirit of the invention shall fall into the scope of invention, including that different technical features, methods appearing in different embodiments are used to combine to advantage. Further, any reference numerals in the claims cannot be recognized as limiting the related claims; the term “comprise” will not preclude another apparatus or step which does not appear in other claims or the description.

I/We claim:

1. A method of supporting multiple QoS in a Listen-Before-Talk operation comprising:
configuring m Listen-Before-Talk priority classes defined respectively by m different parameter sets;
determining Listen-Before-Talk priority classes for respective traffic in a transmission burst; and
selecting one of the determined Listen-Before-Talk priority classes as a Listen-Before-Talk priority class for access.

2. The method according to claim 1, wherein the parameter set includes a defer period and a contention window size.

3. The method according to claim 2, the defer period is determined with the following equation:
16 us+n×eCCASlotTime,
wherein eCCSlotTime is at least 9 us, and n is selected according to different Listen-Before-Talk priority classes.

4. The method according to claim 3, wherein m equals to 4, and n is 2, 2, 3 and 7, respectively, according to a descending order of the Listen-Before-Talk priority classes.

5. The method according to claim 2, wherein for respective Listen-Before-Talk priority classes, a size is selected randomly from an interval of [0, CW] as a random backoff counter window size, wherein CW is the contention window size and is in a range of [CWₘᵢₙ, CWₘₐₓ], and different ranges of [CWₘᵢₙ, CWₘₐₓ] are defined for the respective Listen-Before-Talk priority classes.

6. The method according to claim 2, wherein the parameter set further includes a transmission opportunity.

7. The method according to claim 6, wherein the transmission opportunity of a Listen-Before-Talk priority class with a high priority is less than the transmission opportunity of a Listen-Before-Talk priority class with a low priority.

8. The method according to claim 6, wherein the transmission opportunity is configured according to enhanced distributed channel access parameters in a WiFi system.

9. The method according to claim 1, wherein the step of determining Listen-Before-Talk priority classes for respective traffic in a transmission burst further comprises:
determining the Listen-Before-Talk priority classes for the respective traffic according to respective traffic in a buffer; or
determining the Listen-Before-Talk priority classes for the respective traffic according to respective traffic in a first frame of the transmission burst.

10. The method according to claim 1, wherein the Listen-Before-Talk priority class for access is a Listen-Before-Talk priority class with a highest priority or a Listen-Before-Talk priority class with a lowest priority.

11. The method according to claim 10, wherein the parameter set includes a transmission opportunity if the Listen-Before-Talk priority class for access is the Listen-Before-Talk priority class with the highest priority.

12. The method according to claim 5, further comprising:
if a contention window size trigger condition triggers a binary exponential backoff, performing the binary exponential backoff for a contention window size of a first type of the Listen-Before-Talk priority class in the transmission burst, and applying the contention window size of the Listen-Before-Talk priority class for which the binary exponential backoff is performed to a contention window size of the Listen-Before-Talk priority class in a subsequent transmission burst, wherein the contention window size of the first type of the Listen-Before-Talk priority class is not greater than a contention window size of the Listen-Before-Talk priority class for access in the transmission burst; and
if the contention window size trigger condition triggers a reset, resetting a contention window size of a second type of the Listen-Before-Talk priority class in the transmission burst to a respective CWₘᵢₙ, and applying the CWₘᵢₙ to a contention window size of the Listen-Before-Talk priority class in a subsequent transmission burst, wherein the contention window size of the second type of the Listen-Before-Talk priority class is not less than the contention window size of the Listen-Before-Talk priority class for access in the transmission burst.

13. The method according to claim 5, further comprising:
if a contention window size trigger condition triggers a binary exponential backoff, performing the binary exponential backoff for contention window sizes of all the Listen-Before-Talk priority classes in the transmission burst, and applying the contention window sizes of the Listen-Before-Talk priority classes for which the binary exponential backoff is performed to contention window sizes of the Listen-Before-Talk priority classes in a subsequent transmission burst; and
if the contention window size trigger condition triggers a reset, resetting the contention window sizes of all the Listen-Before-Talk priority classes in the transmission burst to respective CWₘᵢₙ, and applying the CWₘᵢₙ to the contention window sizes of the respective Listen-Before-Talk priority classes in the subsequent transmission burst.

14. The method according to claim 5, further comprising:
if a contention window size trigger condition triggers a binary exponential backoff, performing the binary exponential backoff for a contention window size of the Listen-Before-Talk priority class for access in the transmission burst, and applying the contention window size for which the binary exponential backoff is performed to a contention window size of the Listen-Before-Talk priority class in a subsequent transmission burst; and
if the contention window size trigger condition triggers a reset, resetting the contention window size of the Listen-Before-Talk priority class for access in the transmission burst to a CWₘᵢₙ, and applying the CWₘᵢₙ to the contention window size of the Listen-Before-Talk priority class in the subsequent transmission burst.

15. The method according to claim 5, further comprising:
if the Listen-Before-Talk priority class for access in the transmission burst is same as a Listen-Before-Talk priority class for access in a subsequent transmission burst,
if a contention window size trigger condition triggers a binary exponential backoff, performing the binary exponential backoff for a contention window size of the Listen-Before-Talk priority class for access in the transmission burst, and applying the contention window size for which the binary exponential backoff is performed to a contention window size of the Listen-Before-Talk priority class in the subsequent transmission burst; and
if the contention window size trigger condition triggers a reset, resetting the contention window size of the Listen-Before-Talk priority class for access in the transmission burst to a CWₘᵢₙ, and applying the CWₘᵢₙ to the contention window size of the Listen-Before-Talk priority class in the subsequent transmission burst;
if the Listen-Before-Talk priority class for access in the transmission burst is different from the Listen-Before-Talk priority class for access in the subsequent transmission burst, setting the contention window size of the Listen-Before-Talk priority class for access in the transmission burst to a CWₘᵢₙ, and applying the CWₘᵢₙ to the contention window size of the Listen-Before-Talk priority class in the subsequent transmission burst.
